(19) United States
(12) Patent Application Publication
(10) Pub. No.: US 2026/0288898 A1
(43) Pub. Date: Sep. 24, 2026

(54) METHOD AND CIRCUIT FOR PERFORMING IN-MEMORY MULTIPLICATION AND ACCUMULATION OPERATIONS

(71) Applicants: UNIVERSITE DE LILLE, LILLE (FR); CENTRE NATIONAL DE LA RECHERCHE SCIENTIFIQUE, PARIS (FR); UNIVERSITE POLYTECHNIQUE HAUTS-DE-FRANCE, VALENCIENNES (FR); JUNIA, LILLE (FR)

(72) Inventors: Kévin HÉRISSÉ, LILLE (FR); Benoît LARRAS, LILLE (FR); Antoine FRAPPÉ, LA MADELEINE (FR); Andreas KAISER, VILLENEUVE D'ASCQ (FR)

(21) Appl. No.: 19/132,807

(22) PCT Filed: Nov. 27, 2023
(86) PCT No.: PCT/EP2023/083139

§ 371 Date: Jun. 2, 2026

(30) Foreign Application Priority Data
Nov. 28, 2022 (FR) FR2212440

(51) Int. Cl. G06F 17/16

(52) U.S. Cl. CPC G06F 17/16

(57) ABSTRACT

A trabecular meshwork excision apparatus has a shell and a cutting assembly. The cutting assembly has an outer tube and an inner rod, the outer tube being movably arranged on the shell. One end of the outer tube is an excision port, and the excision port is located outside the shell. The inner rod is connected to the shell. The inner rod penetrates into the outer tube. The inner rod is provided with an insertion end, the insertion end is located outside the outer tube and close to the excision port. An excision recess is formed in the side wall of the insertion end, where the insertion end is matched with the excision port. The insertion end is used for penetrating through the trabecular meshwork tissue. When the outer tube moves towards the insertion end, the insertion end and the excision port cooperate and can be used for excising the trabecular meshwork tissue in the excision recess.

### TECHNICAL FIELD

The present invention relates to the field of in-memory computation, and relates more particularly to a method for performing in-memory multiplication and accumulation and to an associated circuit, in particular for a neural network where the basic operation for a perceptron is multiplication and accumulation (MAC).

### PRIOR ART

The emergence of the Internet of Things is creating a growing demand for ultra-low-consumption computing solutions in order to bring artificial intelligence to such devices. The additional consumption cost preventing machine learning on embedded systems comes from consumption due to data movement.

In a conventional von Neumann architecture, the stored data must be moved from the memory to the processor in order to compute them step by step. In the example provided for the Boris Murmann publication “Mixed-Signal Processing Opportunities for AI”, to perform a MAC operation (one multiplication and one addition), it is necessary to retrieve the data from memory four times. Taking the cost of accessing the data alone, and estimating this access at 50 fJ/byte, the overall consumption is 200 fJ/MAC, capping the efficiency at 10 TOPS/W. One way to alleviate this constraint, known as the memory wall or von Neumann bottleneck, is to bring the processing elements inside the memory to avoid power loss when accessing data.

In-memory computing is a technique that involves carrying out computer calculations entirely in the memory of the computer. In-memory processing is a method for overcoming the disadvantages, particularly in terms of performance and energy costs, caused by moving data between the processor and memory.

FIG. 1 shows the principle of in-memory computation of MAC operations in the prior art. A digital vector [X₁, . . . , Xₘ] is relayed on multiple lines. Multiplication of this vector by elements of a weight matrix W takes place inside the memory where the weight matrix W is stored. Accumulation, in the current or voltage domain, takes place for each column in a capacitive line, also called an accumulation line AL. This mixed-signal method produces the result of the MAC operations in analog, an analog-to-digital converter A/D at the end of each accumulation line AL converting the result to digital, shown by the vector [O₁, . . . , Oₙ], in order for this result to be reusable. Each accumulation line AL is the equivalent of a perceptron without the activation function.

There are different approaches in the prior art for performing such in-memory computation.

In a resistive approach illustrated in FIG. 2 and discussed in the Q. Liu et al. article “A Fully Integrated Analog ReRAM Based 78.4 TOPS/W Compute-In-Memory Chip with Fully Parallel MAC Computing”, memristors are used to perform the multiplication. The vector X is sent in the form of an analog voltage on all the lines. The weights W are stored as conductance values of the memristors, modulating the current through each accumulation line AL. However, this approach requires digital-to-analog converters with high-intensity output currents and a current comparator. It is possible to perform multi-bit operations with this approach using up to 16 conductance states, according to the above article. Process variations prevent a higher number of bits from being reached. Moreover, in terms of energy dissipation, writing requires large current peaks (of the order of 6 μA in the Nguyen Cong Dao et al. publication “Memristor-based Reconfigurable Circuits: Challenges in Implementation”). It should be noted that a compromise exists between energy consumption and variability.

In a capacitive approach illustrated in FIG. 3 and discussed in the D. Bankman et al. publication “An 8-bit, 16 input, 3.2 pJ/op switched-capacitor dot product circuit in 28-nm FDSOI CMOS”, multiplication is based on sharing charges or currents on a capacitive line, typically using XNOR gates for binary multiplication. The unit capacitors are charged according to each binary multiplication and the charges are redistributed to all the capacitors of an accumulation line AL, thereby providing a voltage to be converted by the analog-to-digital converter. To perform a multi-bit operation with switched capacitors, the Boris Murmann article “Mixed-Signal Computing for Deep Neural Network Inference” shows a topology similar to a digital multiplier using an accumulation line for each bit. However, this method requires additional circuits in order to combine all the results of the line, which is sufficient for a reduced number of lines (<5) but increases power consumption for a higher number of bits.

### DISCLOSURE OF THE INVENTION

There is therefore a need to improve in-memory multiplication and accumulation (MAC) techniques, particularly in terms of energy consumption.

Method for Performing in-Memory Multiplication and Accumulation (MAC) Operations

The aim of the invention is to meet this objective and, according to one of its aspects, it provides a method for performing in-memory multiplication and accumulation (MAC) operations, in particular for a neural network, wherein the result of the matrix product O of a vector X=[X₁ X₂ . . . , Xₘ] consisting of m elements, each represented on (n_{X}−1) bits, and a matrix

$$W = [ \begin{matrix}{W}_{1 , 1} & … & {W}_{1 , n} \\ ⋮ & ⋱ & ⋮ \\ {W}_{m , 1} & … & {W}_{m , n}\end{matrix} ]$$

consisting of m×n elements, each represented on (n_{W}−1) bits, is determined:

$$O = [ {X}_{1} {X}_{2} … {X}_{m} ] \times [ \begin{matrix}{W}_{1 , 1} & … & {W}_{1 , n} \\ ⋮ & ⋱ & ⋮ \\ {W}_{m , 1} & … & {W}_{m , n}\end{matrix} ] = [ {O}_{1} {O}_{2} … {O}_{n} ]$$

each element of the matrix product O being the sum of scalar products

$${O}_{i} = {\sum }_{j = 1}^{m} {R}_{j , i} with {R}_{j , i} = ( {\sum }_{c = 0}^{{n}_{X} - 2} {2}^{c} {X}_{j} [ c ] ) ( {\sum }_{d = 0}^{{n}_{W} - 2} {2}^{d} {W}_{j , i} [ d ] ) , \\ i ∈ \{ 1 , … , n \} ,$$

j∈{1, . . . , m}, with the bit vector Xⱼ=[Xⱼ[0], . . . , Xⱼ[n_{X}−2]] and the weight bit vector W_{j,i}=[W_{j,i}[0], . . . , W_{j,i}[n_{W}−2]], the multiplication and accumulation operations leading to the scalar product R_{j,i} by applying to a set of logic gates the values of the vectors Xⱼ and W_{j,i} and those of associated time masks, the time masks PX=[PX(0), . . . , PX(n_{X}−2)] being associated with the bits of the elements of the vector Xⱼ and the time masks PW=[PW(0), . . . , PW(n_{W}−2)] being associated with the bits of the elements of the vector W_{j,i}, so as to generate at least one control signal SC for controlling at least one current source, the control signal SC activating said at least one current source so as to accumulate capacitive charges in an accumulation line, in particular in a manner proportional to the scalar product R_{j,i}.

The expression “performing in-memory multiplication and accumulation (MAC) operations” means carrying out these operations in a memory of the electronic chip where the operands Xⱼ and W_{j,i} are stored.

The expression “activating the current source” means allowing said current source to draw a current flowing in the accumulation line.

The invention provides a new method for in-memory computation of MAC operations by reducing power consumption.

Preferably, at least one of the two vectors is signed, Xⱼ[sign] being the sign bit of the vector Xⱼ and/or W_{j,i}[sign] being the sign bit of the weight bit vector W_{j,i}, the set of logic gates generating a polarity signal SP=Xⱼ[sign]×W_{j,i}[sign] charging or discharging the accumulation line.

The time masks are preferably generated in the form of pulses.

The time masks PX and PW can be generated by a time mask generator unit located outside of memory, that is to say outside of the memory of the electronic chip where the operands Xⱼ and W_{j,i} are stored.

In one embodiment, the time masks PW(d) are generated so as to be activated successively for a period T_{d} substantially equal to

$${2}^{d} * ( {\sum }_{c = 0}^{{n}_{X} - 2} {2}^{c} * T ) ,$$

T being a unit time corresponding to the period of activation of the time mask associated with the least significant bit of the vector Xⱼ, the time masks PX(c) being generated so as to be activated successively for each T_{d} for a period substantially equal to 2^{c+d}*T.

This scenario corresponds to the presence of a single control signal controlling a single absolute-value current intensity value by charging or discharging the accumulation line, such that:

$$SC = {SC}_{j , i} = ( {\sum }_{d = 0}^{{n}_{W} - 2} PW ( d ) * {W}_{j , i} [ d ] ) ( {\sum }_{c = 0}^{{n}_{X} - 2} PX ( c ) * {X}_{j} [ c ] ) , \\ with i ∈ \{ 1 , … , n \} , j ∈ \{ 1 , … , m \} .$$

Here there is a weighting by the activation time of the current source. In this scenario, the voltage V_{O}_{ᵢ} across the terminals of the accumulation line for a multiplication and accumulation operation may be equal to:

$${V}_{{O}_{i}} = \frac{I * T * {O}_{i}}{C}$$

C being the value of the capacitance of the accumulation line and I being the intensity of the current of the current source. Note that the capacitance of the accumulation line can be a parasitic and/or distributed capacitance.

If at least two current sources are present, each being controlled by a respective control signal SC, the time masks PW(d) can be generated so as to be activated successively for a period T_{d} substantially equal to

$${T}_{d} = {2}^{d} * ( {\sum }_{c = 0}^{{n}_{X} - 2} {2}^{c} * T ) ,$$

with d∈{0, . . . , max (bₗ−aₗ)}, the (n_{W}−1) bits of PW being divided into k intervals [aₗ, bₗ], k being the number of current sources or control signals, with l∈{0, . . . , k−1}, bₗ≥aₗ, {aₗ, bₗ}∈[0, (n_{W}−2)], aₗ and bₗ being chosen in such a way that the set of intervals [aₗ, bₗ] represents a partition of the interval [0, n_{W}−2], the longest interval being [0, max(bₗ−aₗ)], T being a unit time corresponding to the period of activation of the time mask associated with the least significant bit of the vector Xⱼ, the time masks PX(c) being generated so as to be activated successively for each T_{d} for a period substantially equal to 2c+d*T.

This scenario corresponds to the presence of multiple control signals SC_{l,j,i} controlling k current sources, k≥2, by charging or discharging the accumulation line, such that:

$$S {C}_{l , j , i} = ( {\sum }_{d = {a}_{l}}^{{b}_{l}} P W ( d - {a}_{l} ) * {W}_{j , i} [ d ] ) ( {\sum }_{c = 0}^{{n}_{X} - 2} P X ( c ) * {X}_{j} [ c ] ) ,$$

$$l ∈ \{ 0 , … , k - 1 \} .$$

Here there is a weighting by the current by having multiple current sources weighted by a power of two and controlled by control signals representative of the values of the bits associated with this weighting. This advantageously increases computation speed by reducing the duration of the control signals. In this case, the voltage V_{O}_{ᵢ} across the terminals of the accumulation line for a multiplication and accumulation operation may be equal to:

$${V}_{{O}_{i}} = \frac{\begin{matrix}T \times {\sum }_{j = 1}^{m} [ ( {\sum }_{l = 0}^{k - 1} {2}^{{a}_{l}} \times I \times \\ ( {\sum }_{d = {a}_{l}}^{{b}_{l}} {2}^{d - {a}_{l}} \times {W}_{j , i} [ d ] ) ) ( {\sum }_{c = 0}^{{n}_{X} - 2} {2}^{c} \times {X}_{j} [ c ] ) ]\end{matrix}}{C} = \frac{T \times {\sum }_{j = 1}^{m} [ ( {\sum }_{d = 0}^{{n}_{W} - 2} {2}^{d} \times I \times {W}_{j , i} [ d ] ) ( {\sum }_{c = 0}^{{n}_{X} - 2} {2}^{c} \times {X}_{j} [ c ] ) ]}{C} = \frac{I * T * {O}_{i}}{C}$$

C being the value of the capacitance of the accumulation line and I being the intensity of the current of the least significant current source (i.e. for aₗ=0).

For example, if (n_{W}−1)=4 and k=2, it is possible to divide the 4 bits evenly between the two sources:

$$S {C}_{0 , j , i} = ( {\sum }_{d = 0}^{1} P W ( d ) * {W}_{j , i} [ d ] ) ( {\sum }_{c = 0}^{{n}_{X} - 2} P X ( c ) * {X}_{j} [ c ] )$$

$$S {C}_{1 , j , i} = ( {\sum }_{d = 2}^{3} P W ( d - 2 ) * {W}_{j , i} [ d ] ) ( {\sum }_{c = 0}^{{n}_{X - 2}} P X ( c ) * {X}_{j} [ c ] )$$

$$Or to divide the bits unevenly :$$

$$S {C}_{0 , j , i} = ( {\sum }_{d = 0}^{2} P W ( d ) * {W}_{j , i} [ d ] ) ( {\sum }_{c = 0}^{{n}_{X - 2}} P X ( c ) * {X}_{j} [ c ] )$$

$$S {C}_{1 , j , i} = P W ( 0 ) * {W}_{j , i} [ 3 ] ( {\sum }_{c = 0}^{{n}_{X} - 2} P X ( c ) * {X}_{j} [ c ] )$$

Circuit for Performing in-Memory Multiplication and Accumulation (MAC) Operations

According to another aspect of the invention, it also provides a circuit for performing in-memory multiplication and accumulation operations, in particular for a neural network, configured to determine the result of the matrix product O of a vector X=[X₁ X₂ . . . , Xₘ] consisting of m elements, each represented on (n_{X}−1) bits, and a matrix

$$W = [ \begin{matrix}{W}_{1 , 1} & … & {W}_{1 , n} \\ ⋮ & ⋱ & ⋮ \\ {W}_{m , 1} & … & {W}_{m , n}\end{matrix} ]$$

consisting of m×n elements, each represented on (n_{W}−1) bits:

$$O = [ \begin{matrix}{X}_{1} & {X}_{2} & … & {X}_{m}\end{matrix} ] \times [ \begin{matrix}{W}_{1 , 1} & … & {W}_{1 , n} \\ ⋮ & ⋱ & ⋮ \\ {W}_{m , 1} & … & {W}_{m , n}\end{matrix} ] = [ \begin{matrix}{O}_{1} & {O}_{2} & … & {O}_{n}\end{matrix} ]$$

each element of the matrix product O being the sum of scalar products

$${O}_{i} = {\sum }_{j = 1}^{m} {R}_{j , i} with$$

$${R}_{j , i} = ( {\sum }_{c = 0}^{{n}_{X} - 2} {2}^{c} {X}_{j} [ c ] ) ( {\sum }_{d = 0}^{{n}_{W} - 2} {2}^{d} {W}_{j , i} [ d ] ) , i ∈ \{ 1 , … , n \} ,$$

j∈{1, . . . , m}, with the bit vector Xⱼ=[Xⱼ[0], . . . , Xⱼ[n_{X}−2]] and the weight bit vector W_{j,i}=[W_{j,i}[0], . . . , W_{j,i}[n_{W}−2]], the circuit comprising:
a logic unit comprising logic gates to which the values of the vectors Xⱼ and W_{j,i} and those of associated time masks are applied, the time masks PX=[PX(0), . . . , PX(n_{X}−2)] being associated with the bits of the elements of the vector Xⱼ and the time masks PW=[PW(0), . . . , PW(n_{W}−2)] being associated with the bits of the elements of the vector W_{j,i}, the logic unit being configured to generate, at its output, at least one control signal SC for activating at least one current source, and
said at least one current source configured to be activated by the control signal SC so as to accumulate capacitive charges in an accumulation line.

Preferably, at least one of the two vectors is signed, Xⱼ[sign] being the sign bit of the vector Xⱼ and/or W_{j,i}[sign] being the sign bit of the weight bit vector W_{j,i}, said accumulation line being configured to be charged or discharged according to a polarity signal SP=X[sign]×W_{j,i}[sign], this signal SP being obtained in particular at the output of an XOR or XNOR logic gate receiving, at its input, the sign bit X[sign] and the sign bit W_{j,i}[sign].

In one embodiment, the logic unit comprises NAND and/or NOR logic gates.

The logic unit can comprise a first logic subunit for time masking the bits Xⱼ and a second logic subunit for time masking the weight bits W_{j,i}, these two subunits being cascaded so that the outputs of the first subunit are at the input of the second subunit.

The first subunit, receiving, at its input, the time masks PX and PW and also the bits Xⱼ[0: n_{X}−2], can comprise two logic gate stages:
a first stage comprising multiple logic gate levels, the levels being connected in cascade so that the signal or signals at the output of one level are the signal or signals at the input of the next level until a single signal is eventually obtained at the output, said first stage being one in which each bit Xⱼ[0: n_{X}−2] and the associated time mask PX are at the input of a first-level logic gate, in particular a NAND or NOR gate; and
a second stage comprising at least one logic gate level, in which the signal at the output of the first stage and each time mask PW are at the input of a logic gate of said level, in particular a NAND or NOR gate.

The second subunit, receiving, at its input, the signals at the output of the first subunit and the weight bits W_{j,i}[0: n_{W}−2], can comprise multiple logic gate levels, the levels being connected in cascade so that the signal or signals at the output of one level are the signal or signals at the input of the next level until a single signal corresponding to the control signal SC is eventually obtained at the output, each first-level logic gate receiving, at its input, a signal at the output of the first subunit and the corresponding weight bit W_{j,i}[0: n_{W}−2].

The second subunit can comprise an XOR or XNOR gate receiving, at its input, the sign bit Xⱼ[sign] of the bit vector Xⱼ and the sign bit W_{j,i}[sign] of the bit vector W_{j,i}. If the positive sign is interpreted as a binary ‘0’ and the negative sign as a binary ‘1’, an XOR gate can be used for the sign bits. If the positive sign is interpreted as a binary ‘1’ and the negative sign as a binary ‘0’, an XNOR gate can be used for the sign bits.

In one embodiment, said at least one current source is created by current mirrors using CMOS transistors.

The current mirrors preferably comprise PMOS transistors for charging the accumulation line and NMOS transistors for discharging said line.

Preferably, the current mirrors have a cascoded architecture. This increases the output impedance of the current mirrors and provides a more stable current value despite the variation in the voltage of the accumulation line.

In one embodiment, the circuit comprises at least one electronic switch, which is in particular a pass gate, controlled by the control signal SC to activate said at least one current source.

The circuit can comprise at least one capacitor at the output of said at least one electronic switch to increase the capacitance of the accumulation line.

The circuit preferably comprises a secondary accumulation line connected to the accumulation line by way of a follower amplifier. Such a secondary accumulation line is for controlling the current.

Preferably, the circuit comprises a follower amplifier connected between the accumulation line and the secondary accumulation line. This has the advantage of allowing each of the two accumulation lines to remain at the same voltage level with the aim of counteracting the charge sharing effect when the switches open and close.

In one embodiment, the circuit comprises an analog-to-digital converter connected either directly to the accumulation line in the absence of a secondary accumulation line or to the secondary accumulation line, in particular by means of a follower amplifier.

The analog-to-digital converter can comprise:
two analog comparators, one comparing with +LSB and the other with −LSB the value of the charge of the accumulation line to which the analog-to-digital converter is connected;
a counter configured to increment or decrement according to the result of the comparison of the comparators, and the output of which is that of the converter;
a charge injector unit configured to return the charge of the accumulation line connected to the converter to its initial value if the counter indicates that this line has been discharged; and
a discharger unit configured to discharge the accumulation line connected to the converter and return it to its initial value if the counter indicates that it has been charged.

The analog-to-digital converter can comprise a look-up table (LUT) receiving, at its input, the output of the counter and being configured to output a substitution value selected during calibration and/or corresponding to an activation function.

In particular, if the values of the table LUT are selected during calibration, the output of the LUT acts via a feedback loop on the values of the reference inputs +LSB and −LSB of the analog comparators and/or on the unit time and/or on the unit current.

The look-up table can be used to correct the nonlinearities of the circuit or to comply with any other kind of response.

It is possible to act on the unit time if there is a single control signal controlling a current source.

It is possible to act on the unit current if there are multiple control signals controlling multiple current sources generating a multiple of this current.

It is possible to act on the values of the reference inputs +LSB and −LSB in either of the above cases. This calibration can be performed at least once to measure the nonlinearities of the circuit, calibrate the circuit and reduce output error.

It is also possible, by selecting appropriate values for the LUT, to imitate an artificial intelligence activation function by adjusting the value of a parameter of control signal generation.

An activation function is used to modify the data nonlinearly. It can be a sigmoid, or Tanh, or ReLU, etc., activation function. In particular, it represents the predefined nonlinear response that it is desirable to obtain.

Alternatively, the analog-to-digital converter comprises:
two analog comparators, each configured to compare the voltage of the accumulation line to which the analog-to-digital converter is connected with a predefined threshold: a first comparator that compares said voltage with a high voltage threshold V_{H}, in particular +LSB, and is configured to be activated when the voltage of the accumulation line is greater than V_{H}, and a second comparator that compares the voltage of the accumulation line with a low voltage threshold V_{L}, in particular with −LSB, and is configured to be activated when the voltage of the accumulation line is less than V_{L};
a digital unit configured to convert the results of the comparisons into two separate output signals: a first signal indicating activation of one of the two comparators and a second signal specifying which of the two comparators has been activated;
a counter configured to be incremented or decremented according to the signals at the output of the digital unit, and the output of which is that of the converter;
a charge injector unit connected to the outputs of the digital unit and configured to return the charge of the accumulation line connected to the converter to its initial value if the digital unit indicates that this line has been discharged; and
a discharger unit connected to the outputs of the digital unit and configured to discharge the accumulation line connected to the converter and return it to its initial value if the digital unit indicates that this line has been charged.

In one embodiment, the analog-to-digital converter comprises a delay circuit that is connected to the outputs of the digital unit and configured to generate a pulse of duration T necessary for charging or discharging the line,
each of the injector and discharger units comprising at least one current source and an associated switch controlled by the delay circuit so as to close the switch associated with the injector unit and open the switch associated with the discharger unit, during the time T, in order to charge the accumulation line until it is returned to its initial value, if the low threshold comparator is activated, indicating that the line has been discharged, creating a voltage drop corresponding to −1 LSB, or to close the switch associated with the discharger unit and open the switch associated with the injector unit, during the time T, in order to discharge the accumulation line until it is returned to its initial value, if the high threshold comparator is activated, indicating that the line has been charged, creating a voltage rise corresponding to +LSB.

In another embodiment, the analog-to-digital converter comprises:
a capacitor network comprising a main capacitor directly connected to the accumulation line and to ground, peripheral capacitors and switches, the capacitance of each peripheral capacitor being proportional to the capacitance of the main capacitor by a factor α corresponding to the charges necessary to compensate for +/−1 LSB, preferably

$$α = \frac{{V}_{H} - {V}_{L}}{{V}_{D D}} ,$$

the peripheral capacitors and the switches forming two branches, the ends of which are connected to the reference voltages, namely V_{DD} and ground, each of the switches being placed between each peripheral capacitor and the main capacitor or between each peripheral capacitor and one of the reference voltages, each pair of switches directly connected to the same peripheral capacitor being controlled by two complementary signals;
an asynchronous finite state machine connected to the outputs of the digital unit and configured to control the switches according to the comparison results; and
non-overlapping clock generation units NOC (Non-Overlapping Clocks) at the output of the state machine, each unit being configured to generate a pair of complementary control signals for controlling the switches, ensuring that the switches do not create a short circuit between one of the reference voltages and the accumulation line.

According to another aspect of the invention, it also provides a method for injecting and collecting charges of the accumulation line of the circuit according to the invention, comprising:
connecting only one of the peripheral capacitors to the main capacitor, called the first peripheral capacitor, this first peripheral capacitor having previously been connected to V_{DD};
when the voltage of the accumulation line reaches the high voltage threshold V_{H}, disconnecting the first peripheral capacitor from the main capacitor and connecting a second peripheral capacitor that has previously been connected to ground; and
when the voltage of the accumulation line reaches the low voltage threshold V_{L}, disconnecting the second peripheral capacitor from the main capacitor and connecting a third peripheral capacitor that has previously been connected to V_{DD}.

According to another aspect of the invention, it also provides a method for initializing the accumulation line of the circuit according to the invention to the voltage V_{DD}/2, wherein the opening and closing of the switches are alternated so that only the peripheral capacitors of the same branch are connected to the main capacitor (310).

In one embodiment, the circuit comprises a time mask generator unit located outside of memory.

In one embodiment, the generator unit is configured to generate the time masks so that the time masks PW(d) are activated successively for a period Ta substantially equal to

$${2}^{d} * ( {\sum }_{c = 0}^{{n}_{X} - 2} {2}^{c} * T ) ,$$

and that the time masks PX(c) are activated successively for each T_{d} for a period substantially equal to 2c+d*T, T being a unit time corresponding to the period of activation of the time mask associated with the least significant bit of the vector Xⱼ.

In this scenario, the circuit according to the invention preferably comprises a single absolute value of current intensity, controlled by a single control signal SC.

In another embodiment, the circuit according to the invention comprises at least two current sources, each being controlled by a respective control signal SC, the generator unit being configured to generate the time masks so that the time masks PW(d) are activated successively for a period T_{d} substantially equal to

$${2}^{d} * ( {\sum }_{c = 0}^{{n}_{X} - 2} {2}^{c} * T ) ,$$

with d∈{0, . . . , max (bₗ−aₗ)}, the (n_{W}−1) bits of PW being divided into k intervals [aₗ, bₗ], k being the number of current sources or control signals, with l∈{0, . . . , k−1}, bₗ≥aₗ, {aₗ, bₗ}∈[0, (n_{W}−2)], aₗ and bₗ being chosen in such a way that the set of intervals [aₗ, bₗ] represents a partition of the interval [0, n_{W}−2], the longest interval being [0, max (bₗ−aₗ)], T being a unit time corresponding to the period of activation of the time mask associated with the least significant bit of the vector Xⱼ, and that the time masks PX(c) are activated successively for each T_{d} for a period substantially equal to 2c+d*T.

In another aspect of the invention, it provides a set of circuits for performing in-memory multiplication and accumulation MAC operations, in particular for a neural network, configured to determine the result of the matrix product of a vector X=[X₁ X₂ . . . , Xₘ] with a weight matrix

$$W = [ \begin{matrix}{W}_{1 , 1} & … & {W}_{1 , n} \\ ⋮ & ⋱ & ⋮ \\ {W}_{m , 1} & … & {W}_{m , n}\end{matrix} ] ,$$

comprising a plurality of circuits according to the invention that are in parallel with each other and share a single time mask generator unit located outside of memory.

### BRIEF DESCRIPTION OF THE DRAWINGS

The invention will be better understood by reading the detailed description, which follows, of non-limiting examples of its implementation, and by examining the appended drawing, in which:

FIG. 1 schematically illustrates the principle of in-memory computation of MAC operations in the prior art;

FIG. 2 schematically shows an example of in-memory computation of MAC operations according to a resistive approach in the prior art;

FIG. 3 schematically illustrates an example of in-memory computation of MAC operations according to a capacitive approach in the prior art;

FIG. 4 is a view of a circuit that schematically shows the principle of in-memory computation of a MAC operation according to the invention;

FIG. 5 recalls the equation of the scalar product of two vectors of 4 bits each;

FIG. 6 shows the variation over time of the terms of the scalar product in FIG. 5;

FIG. 7 shows the curve of the variation over time of the voltage of an accumulation line during a 100 MAC computation;

FIG. 8 illustrates a first example of timing diagrams of time masks;

FIG. 9 shows a second example of timing diagrams of time masks;

FIG. 10 schematically illustrates an example of a first logic subunit for time masking a 4-bit binary vector Xⱼ;

FIG. 11 schematically shows an example of a second logic subunit for time masking a 4-bit binary vector W_{j,i};

FIG. 12 is analogous to FIG. 8 and shows the details of a part of the scalar product of said vectors Xⱼ and W_{j,i} on the basis of the time masks;

FIG. 13 shows the timing diagram of the control signal resulting from a simulation of the scalar product of the vectors X and W given as an example in FIGS. 10 to 12;

FIG. 14 schematically illustrates the architecture of a circuit according to the invention;

FIG. 15 schematically shows a first embodiment of current sources that can be used in the circuit of FIG. 14;

FIG. 16 schematically illustrates a second embodiment of current sources that can be used in the circuit of FIG. 14;

FIG. 17 schematically shows an example of a switch that can be used in the circuit of FIG. 14;

FIG. 18 schematically illustrates an accumulation line that can be used in the circuit of FIG. 14;

FIG. 19 schematically shows an accumulation line and a secondary accumulation line that can be used in the circuit of FIG. 14;

FIG. 20 is similar to FIG. 19, additionally showing switches connected to the accumulation lines;

FIG. 21 schematically shows a first embodiment of an analog-to-digital converter that can be used in the circuit of FIG. 14;

FIG. 22 schematically illustrates a second embodiment of an analog-to-digital converter that can be used in the circuit of FIG. 14;

FIG. 23 schematically shows a third embodiment of an analog-to-digital converter that can be used in the circuit of FIG. 14;

FIG. 24 schematically illustrates an example of architecture of a set of circuits according to the invention with the time weighting approach;

FIG. 25 schematically shows an example of a circuit according to the invention that operates according to the current weighting approach;

FIG. 26 illustrates a first example of timing diagrams of time masks that can be used for the circuit of FIG. 25;

FIG. 27 schematically shows a first example of architecture of a set of circuits according to the invention with the current weighting approach;

FIG. 28 illustrates a second example of timing diagrams of time masks that can be used for the circuit of FIG. 25;

FIG. 29 schematically shows a second example of architecture of a set of circuits according to the invention with the current weighting approach;

FIG. 30 schematically illustrates a fourth embodiment of an analog-to-digital converter that can be used in the circuit of FIG. 14;

FIG. 31 shows a first example of implementation of the converter illustrated in FIG. 30;

FIG. 32 shows a second example of implementation of the converter illustrated in FIG. 30;

FIG. 33 is a timing diagram of the voltages associated with the second example of FIG. 32;

FIG. 34 schematically shows a capacitor network with switches that can be used in the second example of FIG. 32;

FIG. 35 is analogous to FIG. 34 after the switches have switched; and

FIG. 36 schematically shows two instances of the capacitor network of FIG. 34 to illustrate an alternation of opening and closing of switches forming part of said network during the initialization phase.

### DETAILED DESCRIPTION

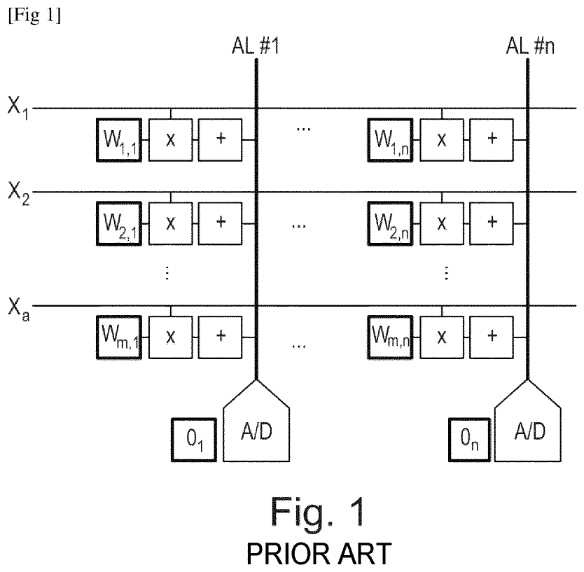

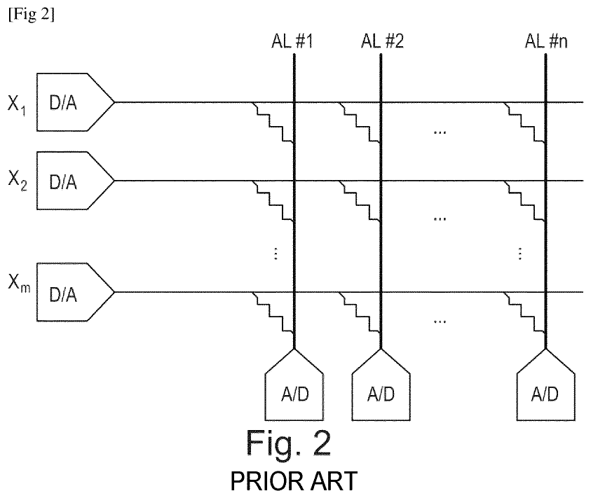

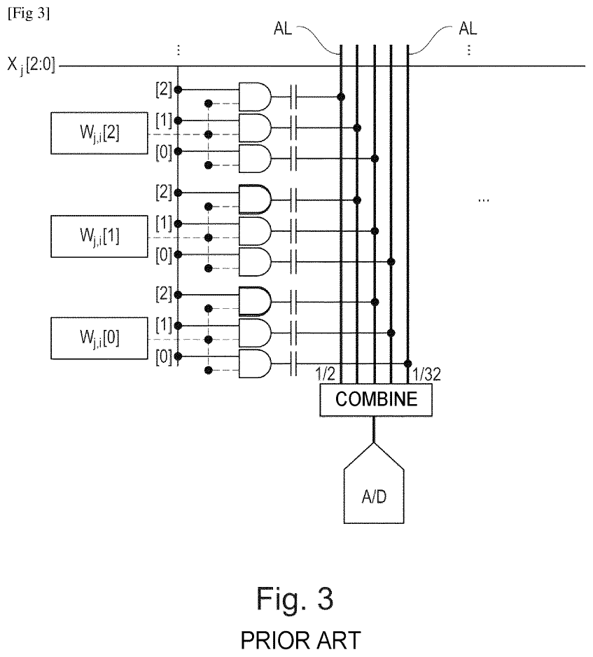

FIGS. 1 to 3 refer to examples from the prior art and have been described above.

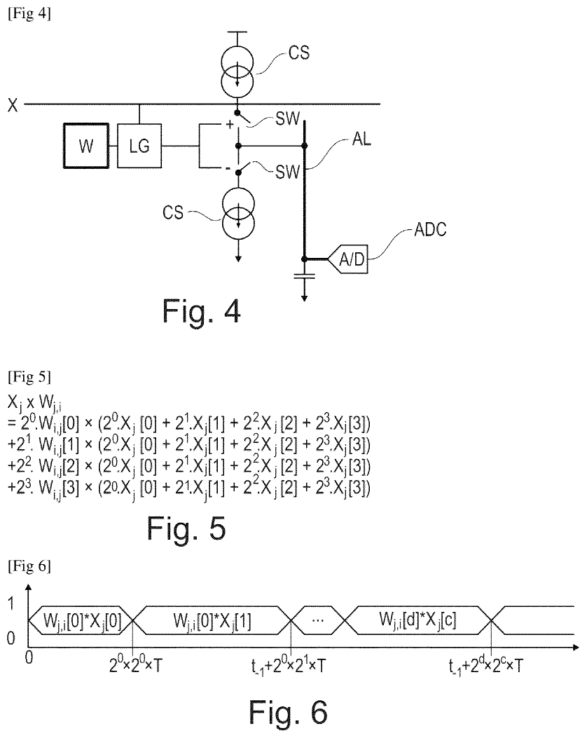

FIG. 4 schematically illustrates a circuit illustrating the principle of in-memory computation of a MAC operation according to the invention. This principle is based on charge accumulation on a capacitive line AL by means of current sources CS. The example illustrated relates to a ternary multiplication of a bit X by a weight bit W taking into account the respective sign bits with which they are associated. Such a ternary multiplication is implemented in a logic unit LG whose output is a control signal that, depending on the sign of the ternary multiplication result, activates a switch SW that permits a current source CS to either charge or discharge the capacitive line AL. The result is then digitized by an analog-to-digital converter ADC.

This principle of charge accumulation on an accumulation line will be extrapolated to a multi-bit multiplication.

FIG. 5 recalls the equation of the scalar product of two vectors, a vector X and a vector of weight W, each of 4 bits.

$${X}_{j} * {W}_{j , i} = {\sum }_{d = 0}^{{n}_{W} - 2} {2}^{d} {W}_{j , i} [ d ] ) ( {\sum }_{c = 0}^{{n}_{X} - 2} {2}^{c} {X}_{j} ) ,$$

with n_{X}=4 and n_{W}=4, the vectors having no sign bit in this example.

A control signal, representing this scalar product, will be used to control current sources.

To this end, the current sources will be activated for a reference unit time T weighted by the weights of the terms of the scalar product in FIG. 5.

FIG. 6 shows such a signal corresponding to the variation over time of the terms of the scalar product in FIG. 5.

Depending on the sign of the scalar product, the accumulation line will be charged or discharged using the current sources.

The method according to the invention utilizes the time required to charge an accumulation line for a long period of time with a low current, courtesy of recent advanced CMOS technology. If a reference unit time T of 20 ns is taken, the total time for a 5-bit MAC operation is 5 μs. For an accumulation line capable of receiving the result of 100 MAC, the throughput is 50 GOPS (Giga Operations Per Second). This throughput is high enough for many applications, such as audio applications, in particular key word spotting (KWS), where a new datum enters every 10 ms.

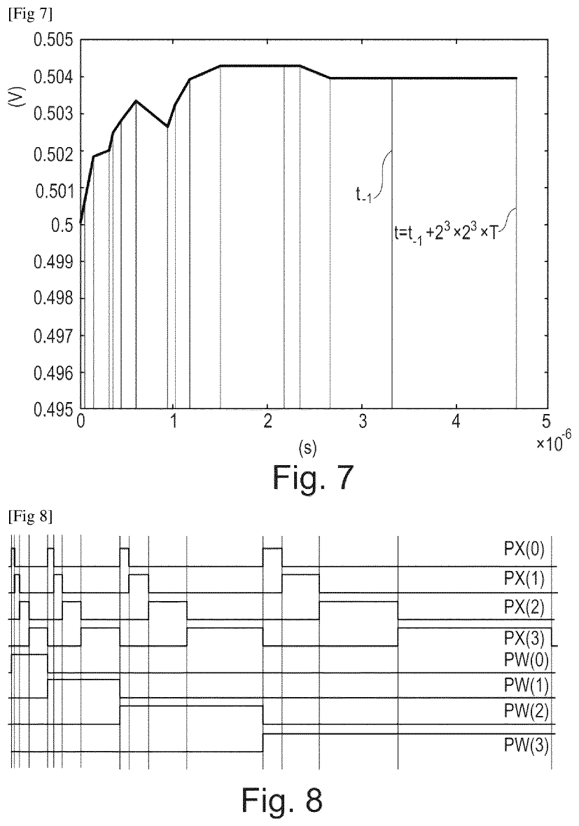

FIG. 7 shows the curve of the variation over time of the voltage of an accumulation line during a 100 MAC computation. The line is initialized to 0.5 V (half the dynamic range of a circuit supplied with power at 1 V) in order to be able to represent negative values.

To obtain the control signal representing the scalar product of the multi-bit vectors Xⱼ and W_{j,i}, a logic unit LG receiving these vectors and associated time masks PX and PW at its input is implemented.

FIG. 8 illustrates a first example of timing diagrams of time masks in which generation of these signals begins with the lowest weighting.

A time mask PX, PW is generated for each bit of the elements of the vector X and of the weight matrix W.

In the case of a 4-bit multiplication, 4 time masks are needed. There are therefore 8 time masks in total: PX=[PX(0), . . . , PX(3)] associated with the bits of the elements of the vector X and PW=[PW(0), . . . , PW(3)] associated with the bits of the elements of the weight matrix W.

The time masks PW(d) are preferably generated so as to be activated successively for a period T_{d} substantially equal to

$${2}^{d} * ( {\sum }_{c = 0}^{3} {2}^{c} * T ) ,$$

T being the reference unit time corresponding to the period of activation of the time mask associated with the least significant bit Xⱼ, the time masks PX(c) being generated so as to be activated successively for each T_{d} for a period substantially equal to 2c+d*T; {c, d}∈{0, . . . , 3}.

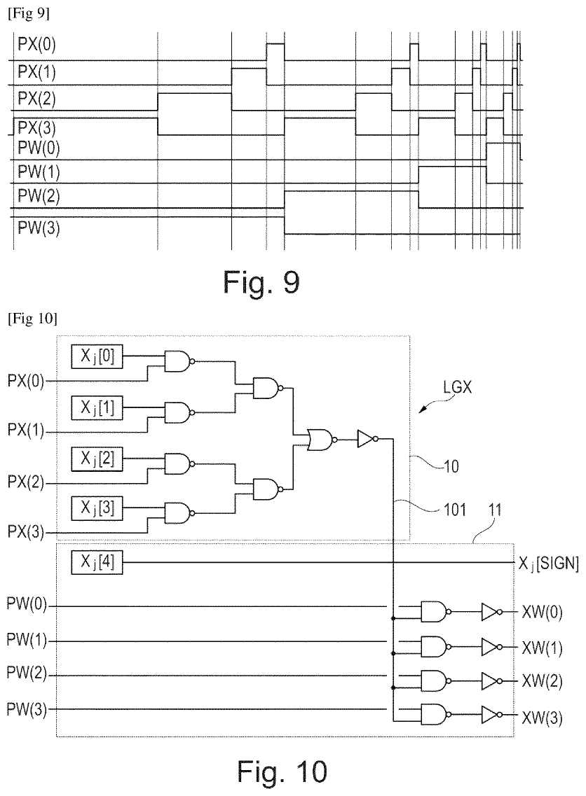

It is also possible for generation of the signals PX and PW to begin with the highest weighting, as illustrated in the example of FIG. 9, or in any order, as long as the time masks PX and PW are synchronized.

The logic unit LG receiving the vectors X and W and the associated time masks PX and PW at its input preferably comprises a first logic subunit for time masking the bits X and a second logic subunit for time masking the weight bits W, these two subunits being cascaded so that the outputs of the first subunit are at the input of the second subunit.

FIG. 10 schematically illustrates an example of a first logic subunit LGX for time masking a 4-bit binary vector Xⱼ.

The first logic subunit LGX comprises two logic gate stages: a first stage 10 and a second stage 11.

In this example, the first stage 10 comprises 4 logic gate levels, the levels being connected in cascade so that the signal or signals at the output of one level are the signal or signals at the input of the next level until a single signal 101 is eventually obtained at the output. Each bit Xⱼ[0], . . . , Xⱼ[3] and the associated time mask PX(0), . . . , PX(3) are at the input of a first-level logic gate, in this case a 2-input NAND gate.

The signal 101 at the output of the first stage therefore represents the following value:

$${\sum }_{c = 0}^{3} P X ( c ) * {X}_{j} [ c ] .$$

The second stage 11 in this example comprises two logic gate levels: a two-input NAND gate level and a NOT gate level. The signal 101 at the output of the first stage and each time mask PW(0), . . . , PW(3) are at the input of a logic gate of the NAND gate level.

The NOT gate level outputs four signals denoted XW (0), . . . , XW(3) that will be injected at the input of the second logic subunit.

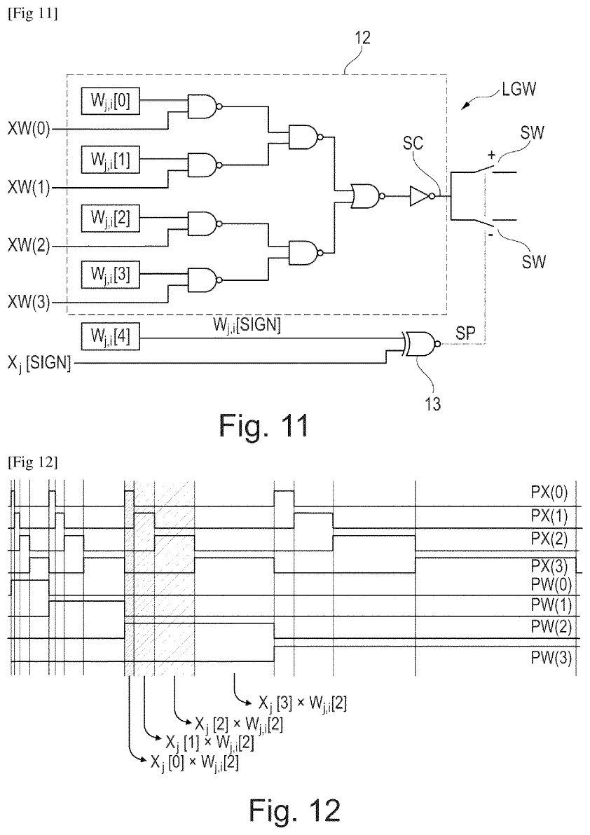

FIG. 11 schematically shows an example of a second logic subunit LGW for time masking the 4-bit weight vector W_{j,i}.

The second subunit LGW receives, at its input, the signals at the output of the first subunit XW(0), . . . , XW(3) and the weight bits W_{j,i}[0], . . . , W_{j,i}[3] and comprises multiple logic gate levels, in this case 4 levels, these levels being connected in cascade so that the signal or signals at the output of one level are the signal or signals at the input of the next level until a single signal corresponding to the control signal SC is eventually obtained at the output. Each first-level logic gate (a two-input NAND gate in this example) receives, at its input, a signal at the output XW (0), . . . , XW(3) of the first subunit LGX and the corresponding weight bit W_{j,i}[0], . . . , W_{j,i}[3]. The signal SC therefore represents the following value:

$$SC = ( {\sum }_{d = 0}^{3} PW ( d ) * {W}_{j , i} [ d ] ) ( {\sum }_{c = 0}^{3} PX ( c ) * {X}_{j} [ c ] ) .$$

The second subunit LGW also comprises an XNOR gate receiving, at its input, the sign bit Xⱼ[sign] of the vector Xⱼ(Xⱼ[4]) and the sign bit W_{j,i}[sign] of the vector W_{j,i} (W_{j,i}[4]). The output of the XNOR gate provides a polarity signal SP=Xⱼ[sign]*W_{j,i}[sign]. On the basis of its value (+ or −) representative of the sign of the scalar product of the vectors Xⱼ and W_{j,i}, SP activates one of the switches SW to charge or discharge the accumulation line AL.

FIG. 12 revisits the timing diagrams of FIG. 8 by showing the details of a part of the scalar product of said vectors Xⱼ and W_{j,i} on the basis of the associated time masks.

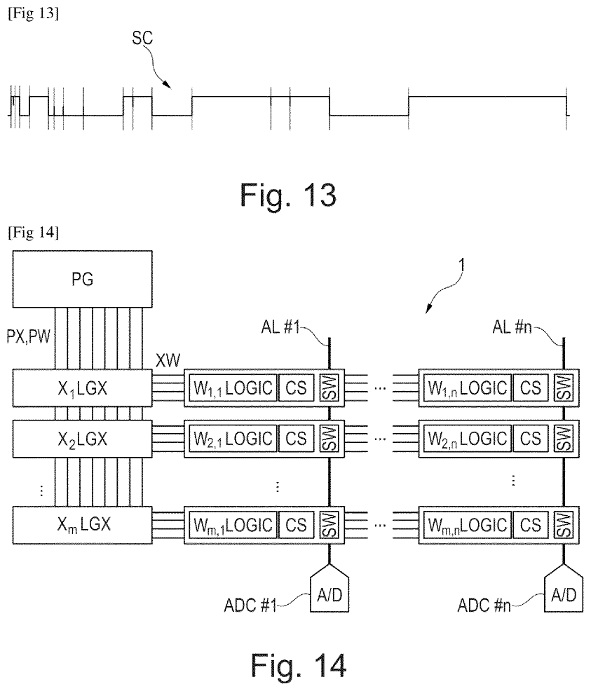

FIG. 13 shows the timing diagram of the control signal SC resulting from a simulation of the scalar product of the vectors Xⱼ and W_{j,i} given as an example in FIGS. 10 to 12. The vectors Xⱼ and W_{j,i} are as follows: Xⱼ=[11010] and W_{j,i}=[10110], the sign bit being the one on the far right. The small peaks seen in the signal SC in FIG. 13 simply indicate a transition to the same state, but this does not happen in reality.

FIG. 14 schematically illustrates the architecture of a circuit 1 according to the invention.

This circuit comprises a generator PG for generating time masks PX, PW, logic subunits LGX, LGW, current sources CS, switches SW, accumulation lines AL and analog-to-digital converters ADC.

The generator PG is preferably located outside of memory and generates time masks PX, PW for all the logic subunits LGX associated with the vectors X₁, . . . , Xₐ.

The outputs XW of the logic subunits LGX are relayed on multiple lines of a weight matrix W: W_{1,1}, . . . , W_{m,1}, W_{1,2}, . . . , W_{m,2}, ( . . . ), W_{1,n}, . . . , W_{m,n}, the second-position indices ranging from 1 to n corresponding to the columns of the matrix.

The values of the vectors X and of the matrix W are preferably stored close to the logic units in order to reduce the cost of accessing the data, by using flip-flop registers or any other memory capable of storing a value without consuming too much power, such as an SRAM memory. Each bit is preferably stored individually to be used at the input of the logic unit.

In this example, each column of the matrix W has an associated accumulation line AL and analog-to-digital converter ADC.

In each row of the weight matrix, the outputs XW are returned to the input of the corresponding logic subunit LGW in order to obtain a control signal and a bias signal (which are not shown in FIG. 14). As explained above, the bias signal is used to control a switch SW that will activate the current source CS connected thereto in order to charge or discharge the accumulation line AL in accordance with the variation over time of the control signal.

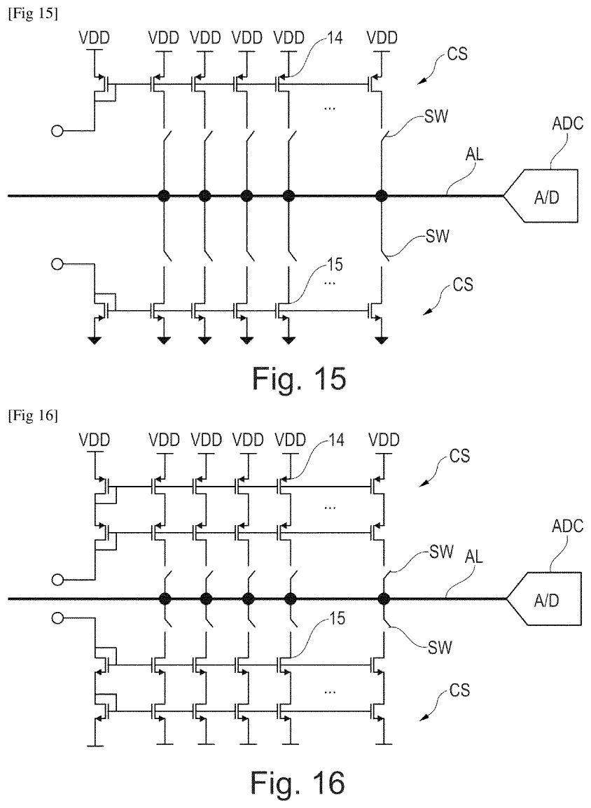

A first embodiment of current sources CS that can be used in the circuit of FIG. 14 is illustrated in FIG. 15.

The current sources CS are created using current mirrors. A current mirror consisting of PMOS transistors 14 charges the accumulation line AL and another mirror consisting of NMOS transistors 15 discharges the accumulation line AL. FIG. 15 shows an accumulation line AL where the outputs of the current mirrors are connected to the accumulation line AL via switches SW. The transistors used can be standard transistors, but when the number of transistors in a current mirror increases, thick oxide transistors can be used to reduce gate leakage.

Since the voltage of the accumulation line AL can vary, it is possible to increase the output impedance of the current mirrors by using a cascoded architecture, as illustrated in FIG. 16. Such an architecture affords a more stable current value over the entire dynamic range [V_{dd}−0], V_{dd} being the supply voltage of the circuit.

Since a current source must be activated and deactivated at multiple voltage levels of the accumulation line, an electronic switch SW of pass gate type (a pass gate switch) is preferably used.

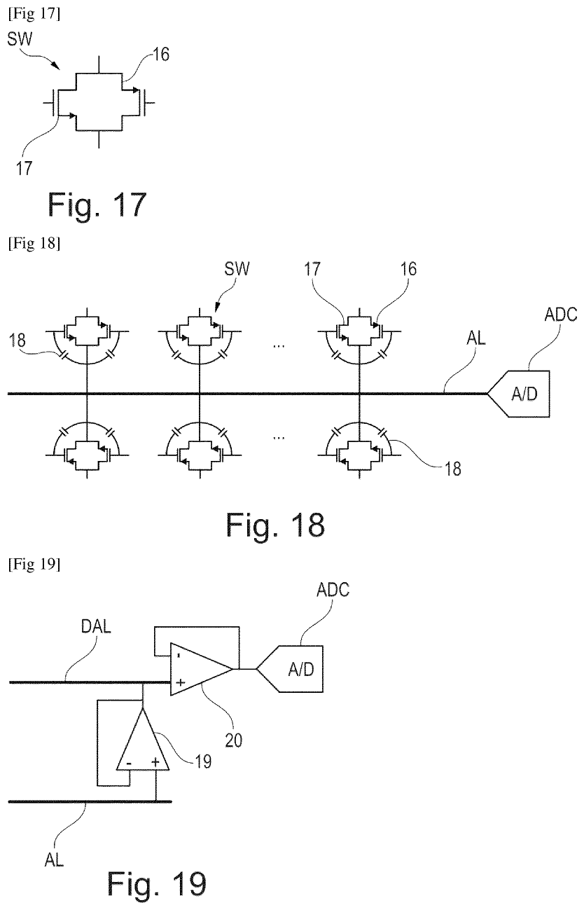

FIG. 17 schematically shows an example of such an electronic switch SW comprising two transistors, one NMOS 17 and one PMOS 16, the drains of which are connected to one another, as are the sources. The signal applied to the gate of one of these transistors is the binary complement of that applied to the gate of the other.

This switch obtains good performance all along the dynamic range.

The accumulation line AL comprises a metal line. Its capacitance is that of the metal line and of all the parasitic capacitances 18 of the electronic switches SW connected to the accumulation line, as illustrated schematically in FIG. 18.

The value of the line is easily estimated in simulations and the value of the current source can be adjusted to match the capacitance of the accumulation line.

The capacitance of the accumulation line can be increased by adding additional capacitors to the output of the switches.

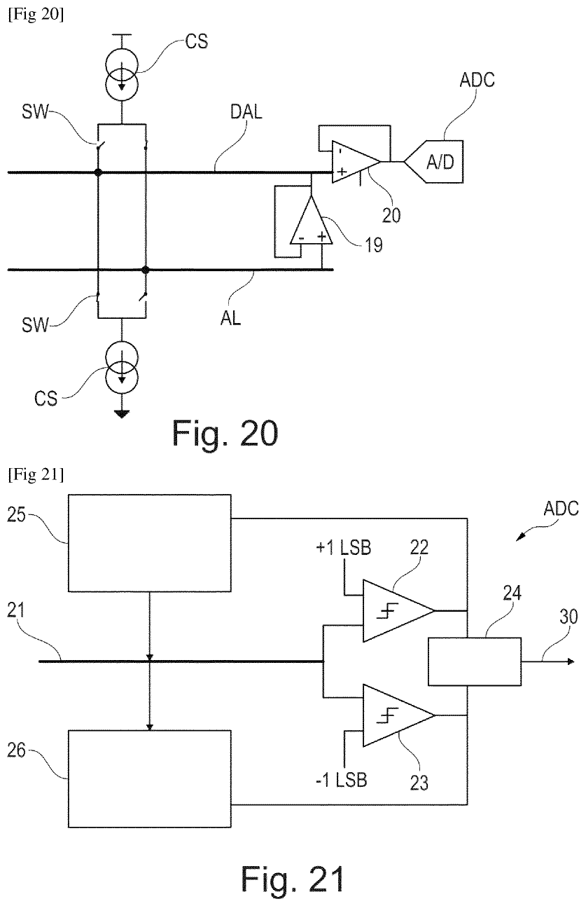

In an embodiment illustrated in FIG. 19, a secondary accumulation line DAL is added to control the current. A follower operational amplifier 19 can be connected between the two accumulation lines AL and DAL so that each remains at the same voltage level with the aim of counteracting the charge sharing effect when the switches SW open and close. FIG. 20 is similar to FIG. 19, additionally showing switches connected to the accumulation lines.

To reduce charge sharing, the secondary accumulation line DAL can be manufactured with a lower capacitance than the accumulation line AL, so that the charges are shared in proportion to the ratio between the capacitances of the two lines.

The analog-to-digital converter ADC is connected either directly to the accumulation line AL in the absence of a secondary accumulation line DAL, or to the secondary accumulation line DAL, in particular by means of a follower operational amplifier 20 as illustrated in FIG. 19.

FIG. 21 schematically shows a first embodiment of an analog-to-digital converter ADC that can be used in the circuit of FIG. 14.

In this example, the analog-to-digital converter ADC comprises two analog comparators 22 and 23, one comparing with +LSB and the other with −LSB the value of the charge of the accumulation line 21 to which the analog-to-digital converter ADC is connected. The analog-to-digital converter also comprises a counter 24 configured to increment or decrement according to the result of the comparison of the analog comparators 22 and 23, and the output 30 of which is that of the converter. The analog-to-digital converter ADC also comprises a charge injector unit 25 configured to return the charge of the accumulation line 21 connected to the converter to its initial value if the counter indicates that this line has been discharged, and a discharger unit 26 configured to discharge the accumulation line 21 connected to the converter and return it to its initial value if the counter 24 indicates that it has been charged.

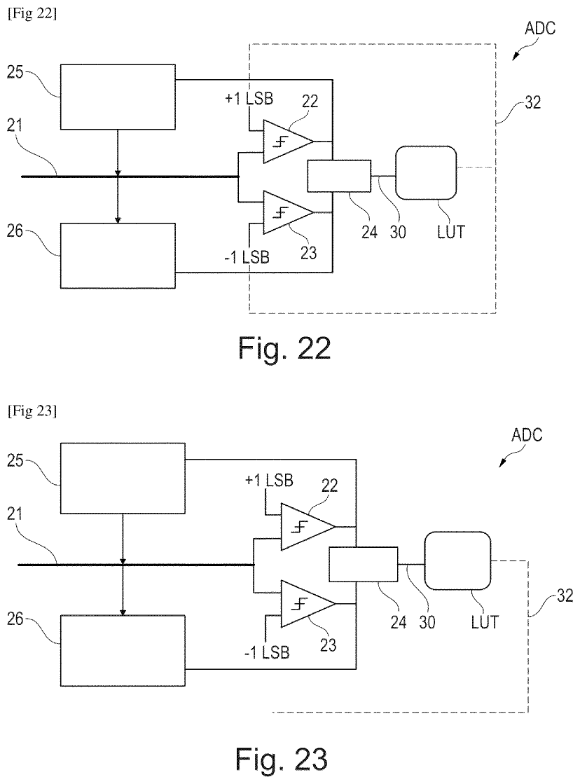

FIGS. 22 and 23 schematically illustrate two variants of the converter of FIG. 21 in which the converter comprises a feedback loop 32 for calibration purposes.

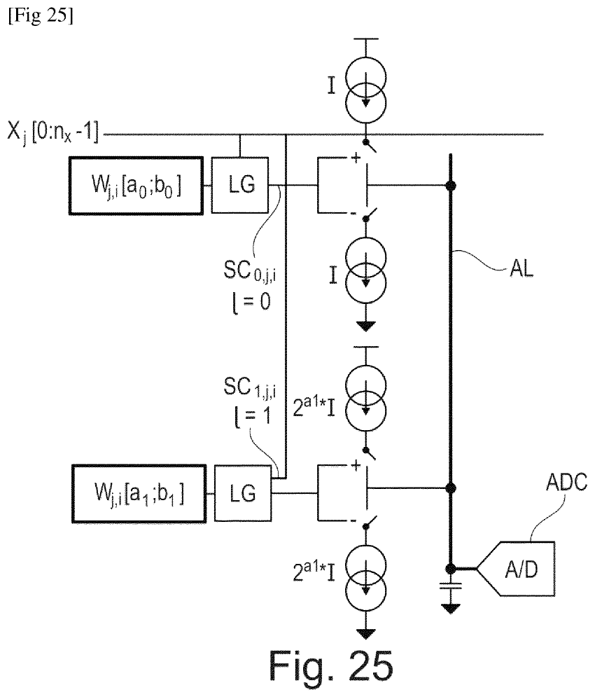

In fact, a feedback loop 32 can be introduced either to modify the value of an LSB according to the value at the output of the counter 24 (scenario illustrated in FIG. 22), or to modify the unit time T in the time mask generator PG (scenario illustrated in FIG. 23). In the case of FIG. 23, the feedback loop 32 can be used to modify, instead of the unit time T, a unit current I of an elementary current source, as will be explained later with reference to FIGS. 25 to 27.

In the variants of FIGS. 22 and 23, the analog-to-digital converter ADC comprises a look-up table LUT that receives, at its input, the output 30 of the counter 24 and is configured to output a substitution value corresponding to an activation function or a correction for calibration purposes. A feedback loop 32 applies the output of the LUT to the values of the reference inputs +LSB and −LSB of the analog comparators 22 and 23 and/or is used to adjust the unit time and/or the unit current.

In the example illustrated in FIG. 22, the feedback loop 32 applies the output of the look-up table LUT to the reference inputs +LSB and −LSB of the comparators 22 and 23.

In the example illustrated in FIG. 23, said loop 32 applies the output of the look-up table LUT to the time mask generator PG to modify the unit time T or to the reference current source to modify the reference current I.

The look-up table can thus be used to calibrate the circuit by correcting nonlinearities or to obtain a predefined nonlinear response that can correspond to an artificial intelligence activation function.

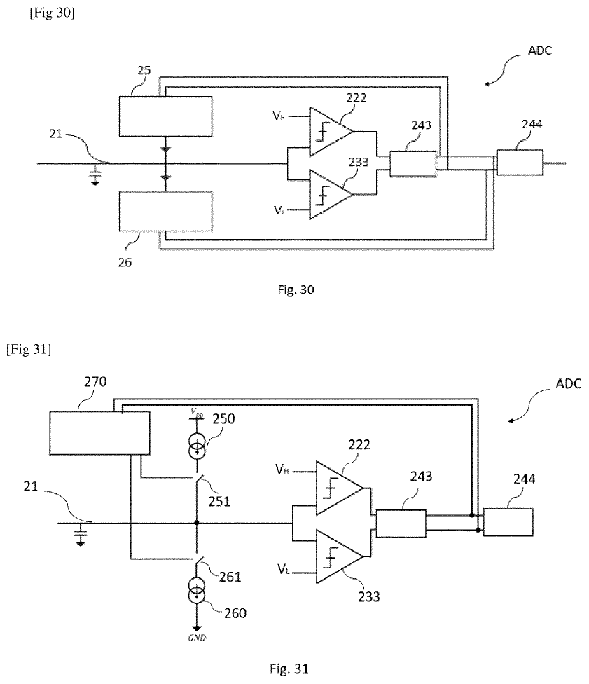

FIG. 30 schematically illustrates a fourth embodiment of an analog-to-digital converter that can be used in the circuit of FIG. 14.

This converter is called a level crossing converter and is connected to an accumulation line whose voltage Vₘ is representative of the result of multiplication and accumulation operations. In the example of FIG. 30, this converter ADC comprises:
two analog comparators 222, 233, each configured to compare the voltage of the accumulation line 21 to which the analog-to-digital converter is connected with a predefined threshold: a first comparator 222 that compares said voltage with a high voltage threshold V_{H}, in particular +LSB, and is configured to be activated when the voltage of the accumulation line 21 is greater than V_{H}, and a second comparator 233 that compares the voltage of the accumulation line 21 with a low voltage threshold V_{L}, in particular with −LSB, and is configured to be activated when the voltage of the accumulation line 21 is less than V_{L};
a digital unit 243 configured to convert the results of the comparisons into two separate output signals: a first signal indicating activation of one of the two comparators and a second signal specifying which of the two comparators has been activated;—a counter 244 configured to increment or decrement according to the signals at the output of the digital unit, and whose output 30 is that of the converter;
a charge injector unit 25 connected to the outputs of the digital unit and configured to return the charge of the accumulation line 21 connected to the converter to its initial value if the digital unit 243 indicates that this line 21 has been discharged; and
a discharger unit 26 connected to the outputs of the digital unit and configured to discharge the accumulation line 21 connected to the converter and return it to its initial value if the digital unit 243 indicates that this line 21 has been charged.

The injector 25 and discharger 26 units can be implemented in different ways, two of which are described below: a first method involving using current sources to charge/discharge the accumulation line and a second method involving using a capacitor network.

FIG. 31 shows an example of implementation of the converter illustrated in FIG. 30 according to the first method, with current sources.

In this example, the analog-to-digital converter ADC comprises a delay circuit 270 that is connected to the outputs of the digital unit 243 and configured to generate a pulse of duration T necessary for charging or discharging the line. Each of the injector 25 and discharger 26 units comprises at least one current source 250; 260 and an associated switch 251; 261 controlled by the delay circuit 270 so as to close the switch associated with the injector unit and open the switch associated with the discharger unit, during the time T, in order to charge the accumulation line until it is returned to its initial value, if the low threshold comparator is activated, indicating that the line has been discharged, creating a voltage drop corresponding to −1 LSB, or to close the switch associated with the discharger unit and open the switch associated with the injector unit, during the time T, in order to discharge the accumulation line until it is returned to its initial value, if the high threshold comparator is activated, indicating that the line has been charged, creating a voltage rise corresponding to +LSB.

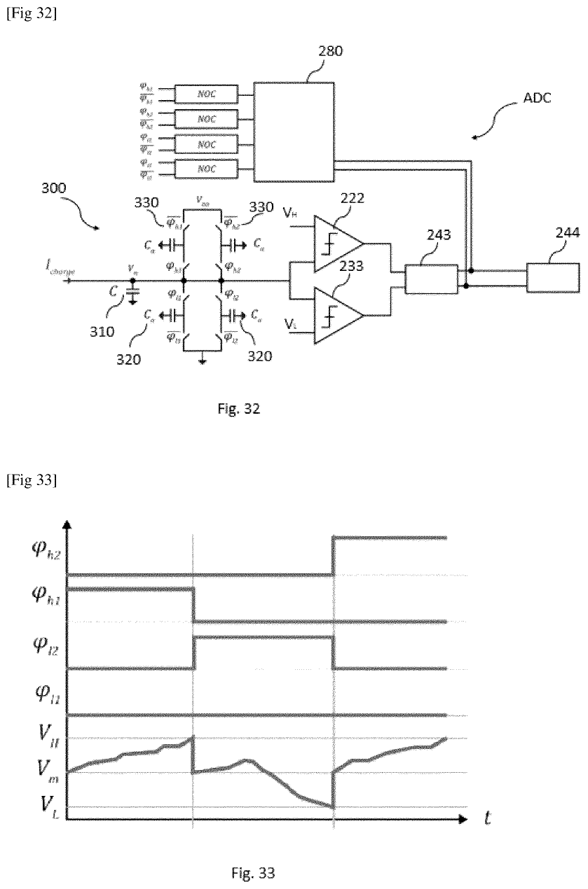

FIG. 32 shows an example of implementation of the converter illustrated in FIG. 30 according to the second method, with a capacitor network.

In this example, the analog-to-digital converter ADC comprises a capacitor network 300, a finite state machine 280 and non-overlapping clock generation units (NOC, Non-Overlapping Clocks).

The capacitor network 300 comprises a main capacitor 310 directly connected to the accumulation line 21 and to ground, peripheral capacitors 320 and switches 330. The capacitance Ca of each peripheral capacitor 320 is proportional to the capacitance C of the main capacitor 310 by a factor α corresponding to the charges necessary to compensate for +/−1 LSB, i.e. C_{α}=α C. The peripheral capacitors 320 and the switches 330 form two branches, the ends of which are connected to the reference voltages, namely V_{DD} and ground. The switches 330 are each placed between each peripheral capacitor 320 and the main capacitor 310 or between each peripheral capacitor 320 and one of the reference voltages. Each pair of switches directly connected to the same peripheral capacitor is controlled by two complementary signals, for example φₕ₁ and φ̅ₕ̅₁̅.

The asynchronous finite state machine 280 connected to the outputs of the digital unit 243 is configured to control the switches 330 according to the comparison results.

The non-overlapping clock generation units NOC are at the output of the state machine 280. Each unit NOC is configured to generate a pair of complementary control signals for controlling the switches 330, for example φₗ₂ and φ̅ₗ̅₂̅, ensuring that the switches do not create a short circuit between one of the reference voltages and the accumulation line.

FIG. 33 is a timing diagram of the voltages associated with the second example of FIG. 32. This timing diagram shows the order of operation to reset the accumulation line 21. First, there is one of the capacitances C_{α} located on a first branch that is connected to C (all peripheral capacitances having the same value). In this example, the first connected capacitance is that associated with the switch controlled by the signal φₕ₁. The current I_{charge} charges the capacitive line 21. When the voltage of the line Vₘ reaches V_{H}, an opposite capacitance (located on the second branch and initially connected to ground) is then connected to C, resetting the line to Vₘ; here the control signal 412 for controlling the associated switch is at 1. The signal φₕ₁ is then at zero and computation continues until one of the two comparators is next triggered. Indeed, when the line 21 discharges again and the voltage of the line Vₘ reaches V_{L}, an opposite capacitance (located on the first branch and initially connected to V_{DD}) is then connected to C, resetting the line to Vₘ; here the control signal φₕ₂ for controlling the associated switch is at 1. The signal φₗ₂ is then at zero.

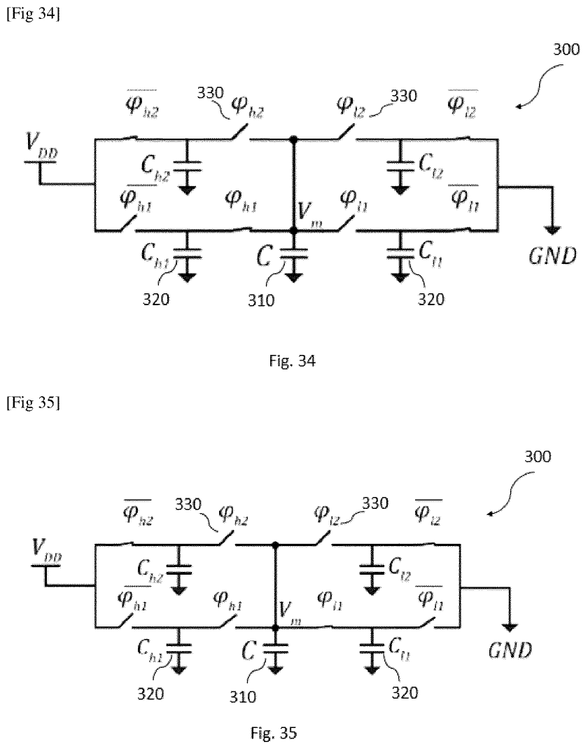

The diagram in FIG. 34 shows an example of a capacitor network 300 that can be used in the second example of FIG. 32, consisting of a main capacitor 310 of capacitance C, which corresponds to the capacitance of the accumulation line 21, and of the peripheral capacitors 320 having, as capacitances, Cₕ₁, Cₕ₂, Cₗ₁ and Cₗ₂, all with the same values equal to C_{α}=α. C. The operating principle of the circuit of FIG. 34 is as follows. Let us assume that the voltage Vₘ of the line 21 is initialized to

$$\frac{V DD}{2}$$

When the line charges, the voltage Vₘ increases until it reaches V_{H}.

The charges are as follows:

$${Q}_{h 1} = {C}_{h 1} {V}_{H} , {Q}_{C} = C {V}_{H} and {Q}_{l 1} = 0$$

the switch controlled by φₗ₁ closes and the switch controlled by φₕ₁ opens, as shown in FIG. 35, which is analogous to FIG. 34, after the switches have switched.

The charges are now: Q_{C}=CVₘ and Qₗ₁=Cₗ₁Vₘ.

We therefore have:

$$C {V}_{H} = {V}_{m} ( C + {C}_{l 1} )$$

$${V}_{m} = \frac{{C V}_{H}}{C + {C}_{l 1}}$$

Now, if we perform the same calculation with Vₘ, arriving at V_{L} instead of V_{H}, the switch controlled by φₕ₂ will close and the switch controlled by φₕ₁ will open. The charges before switching are Qₕ₂=Cₕ₂V_{DD}, Q_{C}=CV_{L} and Qₕ₁=Cₕ₁V_{L}. After switching, the charges are: Qₙ₂=Cₕ₂Vₘ and Q_{C}=CVₘ.

We therefore have:

$${C}_{h 2} {V}_{DD} + C {V}_{L} = {V}_{m} ( {C}_{h 2} + C )$$

$${V}_{m} = \frac{{C}_{h 2} {V}_{DD}}{C + {C}_{h 2}} + \frac{C {V}_{L}}{C + {C}_{h 2}}$$

Now, if we assume Cₗ₁=Cₗ₂=Cₕ₁=Cₕ₂=C_{α}≠C, the value of Vₘ must be the same in the two configurations described previously. We have:

$$\frac{{C}_{α} {V}_{DD}}{C + {C}_{α}} + \frac{C {V}_{L}}{C + {C}_{α}} = \frac{C {V}_{H}}{C + {C}_{α}}$$

$${C}_{α} = \frac{{V}_{H} - {V}_{L}}{{V}_{DD}} C$$

We now know the value of C_{α} as a function of C, the supply voltage V_{DD} and the LSB values provided by V_{H} and V_{L}. The possible voltage step is therefore

$$\pm \frac{{V}_{H} - {V}_{L}}{2} .$$

It is thus possible to inject/remove charges into/from the line 21 by switching the capacitances, the voltage jump created being equal to

$$\pm \frac{{V}_{H} - {V}_{L}}{2} .$$

To initialize the line 21 to the voltage

$${V}_{m} = \frac{V DD}{2} ,$$

it is possible to alternate the connection and disconnection of the pairs φₕ₁ and φₗ₁ and the pairs φₕ₂ and φₗ₂.

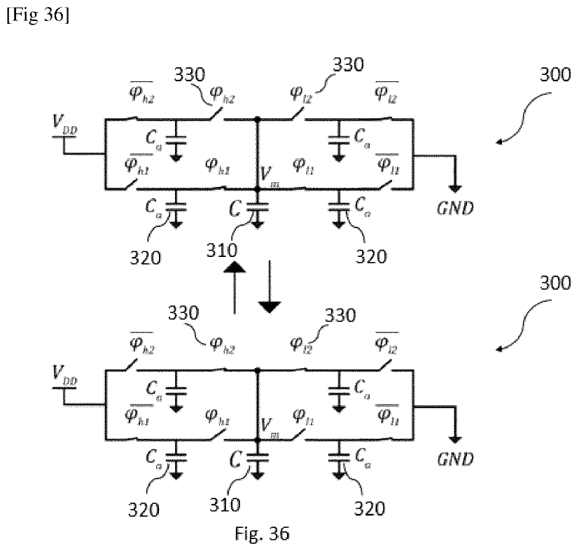

FIG. 36 schematically shows two instances of the capacitor network 300 of FIG. 34 to illustrate an alternation of opening and closing of the switches 330 forming part of said network. Indeed, the opening and closing of the switches are alternated so that only the peripheral capacitors 320 of the same branch are connected to the main capacitor 310.

Let us assume that the initial voltage is Vₘ_{ₖ₋₁}. Initially, the charges are Q_{C}=Vₘ_{ₖ₋₁}C, Qₕ₁=C_{α}VDD and Qₗ₁=0. The switches controlled by φₕ₁ and φₗ₁. are then closed. In this case, the charges are as follows Q_{C}=Vₘ_{ₖ}C, Qₕ₁=C_{α}Vₘ_{ₖ} and Qₗ₁=C_{α}Vₘ_{ₖ}, and the charge conservation law implies that:

$${V}_{{m}_{k}} = \frac{{V}_{{m}_{k - 1}} C + {C}_{α} V DD}{C + 2 {C}_{α}}$$

Taking into account that C_{α}=αC, we then obtain:

$${V}_{{m}_{k}} = \frac{{V}_{{m}_{k - 1}} + α V DD}{1 + 2 α}$$

When the switches controlled by φₕ₂ and φₗ₂ will then be switched, then also applying the charge conservation law we obtain:

$${V}_{{m}_{k + 1}} = \frac{{V}_{{m}_{k}} + α V DD}{1 + 2 α}$$

If Vₘ_{ₖ} is substituted with

$$\frac{{V}_{DD}}{2} + {ϵ}_{k} ,$$

we obtain.

$${V}_{{m}_{k + 1}} = \frac{\frac{{V}_{DD}}{2} ( 1 + 2 α ) + {ϵ}_{k}}{1 + 2 α} = \frac{{V}_{DD}}{2} + \frac{{ϵ}_{k}}{1 + 2 α}$$

By performing k switching operations, the error therefore becomes

$${ϵ}_{k} = \frac{{ϵ}_{k - 1}}{1 + 2 α} = \frac{{ϵ}_{0}}{{( 1 + 2 α )}^{k}}$$

with ϵ₀ the initial error, and ϵₖ tends towards 0, implying that Vₘ converges towards

$$\frac{{V}_{DD}}{2} .$$

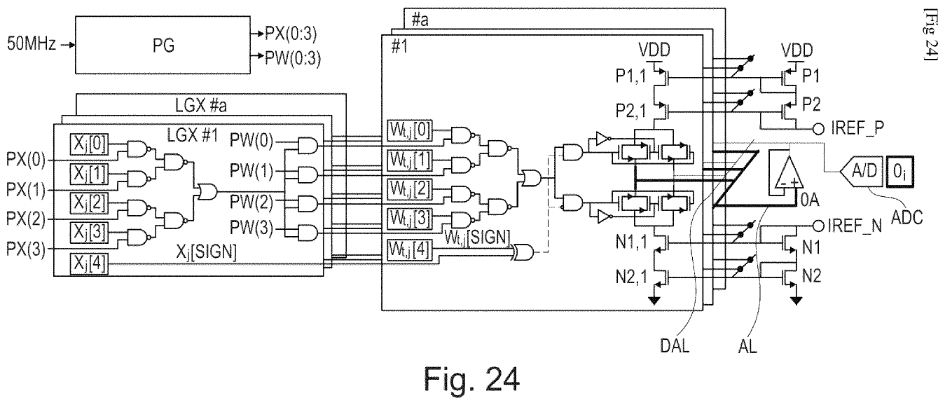

FIG. 24 schematically illustrates the architecture of a set of circuits for performing in-memory multiplication and accumulation MAC operations, in particular for a neural network, configured to determine the result of the matrix product of a vector [X₁, . . . , Xₘ] with a weight matrix ([W_{1,1}, . . . , W_{m,1}], . . . , [W_{1,n}, . . . , W_{m,n}]), comprising a plurality of circuits according to the invention that are in parallel with each other and share a single time mask generator unit PG, located outside of memory, and operate for example at 50 MHz.

FIG. 25 schematically shows a circuit according to the invention operating according to the current weighting approach.

Referring to the preceding figures, it has been seen that it was possible to use a current source CS by weighting the charging/discharging time for the accumulation line AL. The voltage across the terminals of the accumulation line AL for a multiplication and accumulation (MAC) operation is equal to:

$${V}_{{O}_{i}} = \frac{I * T * {O}_{i}}{C}$$

C being the value of the capacitance of the accumulation line and I being the intensity of the current of the current source CS.

It is possible to obtain the same scalar product result R by weighting the current and reducing the charging/discharging time.

According to the current weighting approach, there are multiple current sources (k being the number of current sources) weighted by a power of two and controlled by control signals SC representative of the values of the bits associated with this weighting.

This advantageously increases computation speed by reducing the duration of the control signals.

In the example illustrated in FIG. 25, there are two control signals SC_{0,j,i} and SC_{1,j,i} that activate the current sources of intensities I and 2^{l}*I, respectively, I being the reference elementary current associated with the least significant bits of index 0 to (k−1). In this example, k−2, since there are only two control signals.

The generation of the time masks PX is the same as in the case of the time weighting seen above, but the generation of the time masks PW differs.

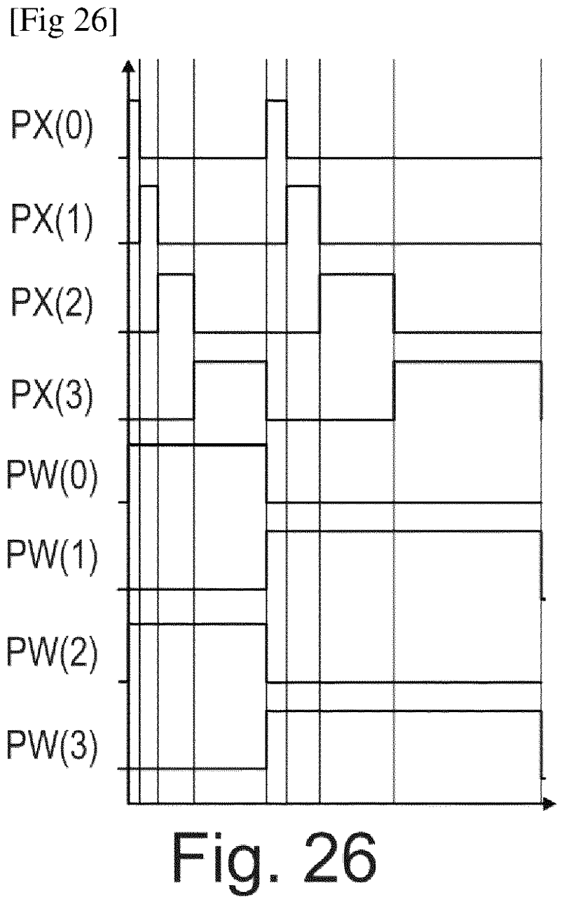

Indeed, if we take the example of a 4-bit multiplication (without the sign bit), the time masks PX and PW are shown in FIG. 26.

The computation takes half as long as if a time weighting were involved, and the signals of PW(0) and PW(2) are identical, as are PW(1) and PW(3). Indeed, the same signals are used, but on different current sources.

In the example of the timing diagrams shown in FIG. 26, the 4 bits are evenly distributed between the two sources, so that the control signals are such that:

$${SC}_{0 , j , i} = ( {\sum }_{d = 0}^{1} PW ( d ) * {W}_{j , i} [ d ] ) ( {\sum }_{c = 0}^{{n}_{X} - 2} PX ( c ) * {X}_{j} [ c ] )$$

$${SC}_{1 , j , i} = ( {\sum }_{d = 2}^{3} PW ( d - 2 ) * {W}_{j , i} [ d ] ) ( {\sum }_{c = 0}^{{n}_{X} - 2} PX ( c ) * {X}_{j} [ c ] ) .$$

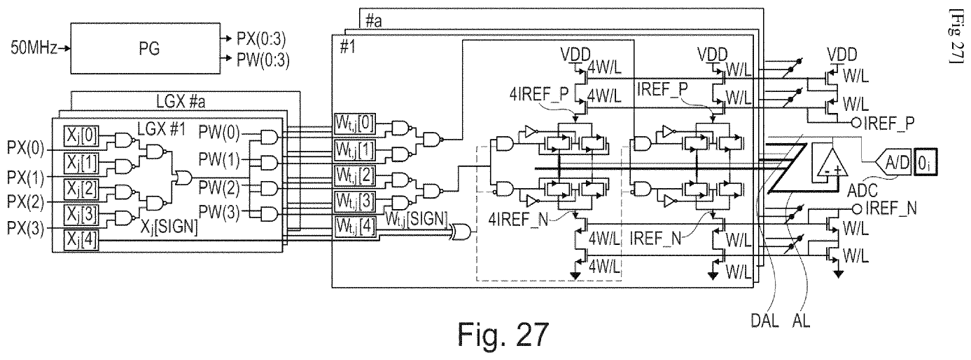

FIG. 27 is analogous to FIG. 24 showing a set of circuits according to the invention, with the current weighting variant, in the case of a 4-bit multiplication with even distribution of the bits between the 2 current sources.

The reference current for charging is denoted by I_{ref_P} and the reference current for discharging is denoted by I_{ref_N}, with I_{ref_P}=I_{ref_N}. The transistors of the corresponding current sources are dimensioned so as to provide such a current intensity. The ratio W/L is related to transconductance gm, which is defined as the ratio between the variation of the drain current and the variation of the gate-source voltage. Thus, for a given gate-source voltage, a higher W/L ratio leads to a higher current, W being the width of the conductive channel and L being its length. The transistors of the current sources with higher weighting have a ratio of 4W/L.

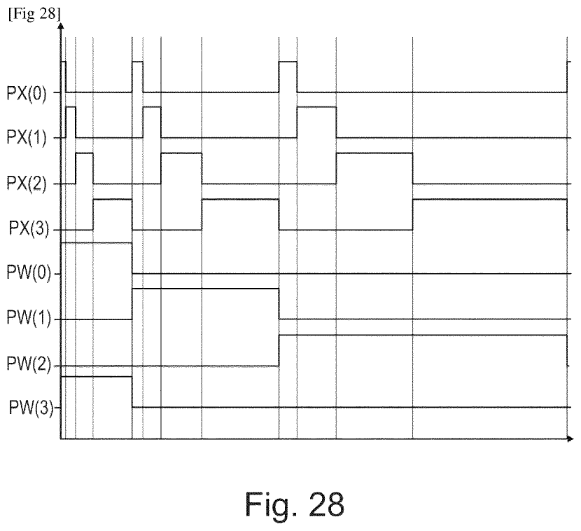

FIG. 28 illustrates a second example of timing diagrams of time masks that can be used for the circuit of FIG. 25. In this example, the 4 bits are unevenly distributed between the 2 sources, so that the control signals are such that:

$${SC}_{0 , j , i} = ( {\sum }_{d = 0}^{2} PW ( d ) * {W}_{j , i} [ d ] ) ( {\sum }_{c = 0}^{{n}_{X} - 2} PX ( c ) * {X}_{j} [ c ] )$$

$${SC}_{1 , j , i} = PW ( 0 ) * {W}_{j , i} [ 3 ] ( {\sum }_{c = 0}^{{n}_{X} - 2} PX ( c ) * {X}_{j} [ c ] )$$

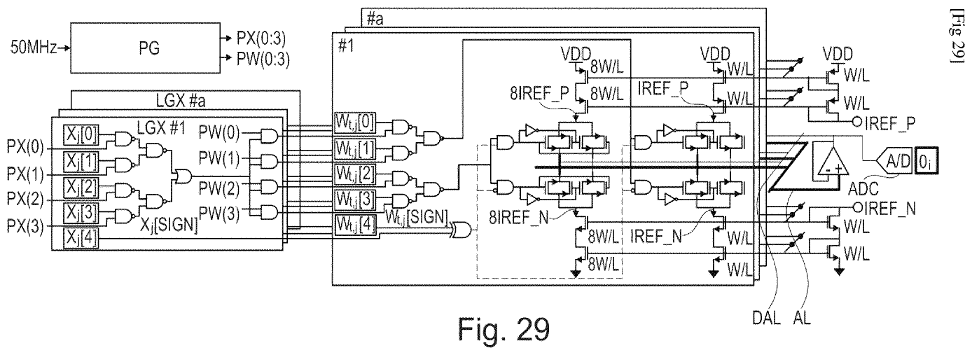

FIG. 29 is analogous to FIG. 27 showing a set of circuits according to the invention, with the current weighting variant, in the case of a 4-bit multiplication with uneven distribution of the bits between the 2 current sources.

The transistors of the current sources with higher weighting have a ratio of 8W/L. Indeed, since the second current source is controlled only by the bit W_{j,i}[3] and PW(3) is equivalent to PW(0), the current carries the weighting 2³. It is therefore necessary to modify the size of the transistor by the same factor.

Applications for the invention include optimization of computations in preprocessors, perceptrons and classifiers.

The invention is not limited to the exemplary embodiments described above. For example, the logic unit can be implemented with different logic gates, typically NOR gates instead of NAND gates. The frequency of the time mask generator unit can be modified to meet the needs of the target application.

1. A method for performing in-memory multiplication and accumulation (MAC) operations for a neural network comprising the result of the matrix product O of a vector X=[X₁ X₂ . . . Xₘ] including m elements, each represented on (n_{X}−1) bits, and a matrix
$$W = [ \begin{matrix}{W}_{1 , 1} & ⋯ & {W}_{n , 1} \\ ⋮ & ⋱ & ⋮ \\ {W}_{m , 1} & ⋯ & {W}_{m , n}\end{matrix} ]$$
including m×n elements, each represented on (n_{W}−1) bits, is determined:
$$O = [ \begin{matrix}{X}_{1} & {X}_{2} & … & {X}_{m}\end{matrix} ] \times [ \begin{matrix}{W}_{1 , 1} & ⋯ & {W}_{n , 1} \\ ⋮ & ⋱ & ⋮ \\ {W}_{m , 1} & ⋯ & {W}_{m , n}\end{matrix} ] = [ \begin{matrix}{O}_{1} & {O}_{2} & … & {O}_{n}\end{matrix} ]$$
each element of the matrix product O being the sum of scalar products
$${O}_{i} = {\sum }_{j = 1}^{m} {R}_{j , i} with {R}_{j , i} = ( {\sum }_{c = 0}^{{n}_{X} - 2} {2}^{c} {X}_{j} [ c ] ) ( {\sum }_{d = 0}^{{n}_{W} - 2} {2}^{d} {W}_{j , i} [ d ] ) , i ∈ \{ 1 , … , n \} , j ∈ \{ 1 , … , m \} ,$$
with the bit vector Xⱼ=[Xⱼ[0], . . . , Xⱼ[n_{X}−2]] and the weight bit vector
W_{j,i}=[W_{j,i}[0], . . . , W_{j,i}[n_{W}−2]],
the multiplication and accumulation operations leading to the scalar product R_{j,i} by applying to a set of logic gates the values of the vectors Xⱼ and W_{j,i} and those of associated time masks, the time masks PX=[PX(0), . . . , PX(n_{X}−2)] being associated with the bits of the elements of the vector Xⱼ and the time masks PW=[PW(0), . . . , PW(n_{W}−2)] being associated with the bits of the elements of the vector W_{j,i}, so as to generate at least one control signal SC for controlling at least one current source, the control signal SC activating said at least one current source so as to accumulate capacitive charges in an accumulation line in a manner proportional to the scalar product R_{j,i}.

2. The method as claimed in claim 1, wherein at least one of the two vectors is signed, Xⱼ[sign] being the sign bit of the vector Xⱼ and/or W_{j,i}[sign] being the sign bit of the weight bit vector W_{j,i}, the set of logic gates generating a polarity signal SP=Xⱼ[sign]×W_{j,i}[sign] charging or discharging the accumulation line.

3. The method as claimed in claim 1, the time masks PX and PW being generated in the form of pulses.

4. The method as claimed in claim 1, the time masks PX and PW being generated by a time mask generator unit located outside of memory.

5. The method as claimed in claim 1, the time masks PW(d) being generated so as to be activated successively for a period T_{d} substantially equal to
$${2}^{d} * ( {\sum }_{c = 0}^{{n}_{X} - 2} {2}^{c} * T ) ,$$
T being a unit time corresponding to the period of activation of the time mask associated with the least significant bit of the vector Xⱼ, the time masks PX(c) being generated so as to be activated successively for each T_{d} for a period substantially equal to 2^{c+d}*T.

6. The method as claimed in claim 5, the control signal SC controlling a single absolute-value current intensity value by charging or discharging the accumulation line, such that:
$$SC = {SC}_{j , i} = ( {\sum }_{d = 0}^{{n}_{W} - 2} PW ( d ) * {W}_{j , i} [ d ] ) ( {\sum }_{c = 0}^{{n}_{X} - 2} PX ( c ) * {X}_{j} [ c ] ) , with i ∈ \{ 1 , … , n \} , j ∈ \{ 1 , … , m \} .$$

7. The method as claimed in claim 1, at least two current sources being present, each being controlled by a respective control signal SC, the time masks PW(d) being generated so as to be activated successively for a period T_{d} substantially equal to
$${T}_{d} = {2}^{d} * ( {\sum }_{c = 0}^{{n}_{X} - 2} {2}^{c} * T ) ,$$
with d∈{0, . . . , max (bₗ−aₗ)}, the (n_{W}−1) bits of PW being divided into k intervals [aₗ, bₗ], k being the number of current sources or control signals, with l∈{0, . . . , k−1}, bₗ≥aₗ, {aₗ, bₗ}∈[0, (n_{W}−2)], aₗ and bₗ being chosen in such a way that the set of intervals [aₗ, bₗ] represents a partition of the interval [0, n_{W}−2], the longest interval being [0, max (bₗ−aₗ)], T being a unit time corresponding to the period of activation of the time mask associated with the least significant bit of the vector Xⱼ, the time masks PX(c) being generated so as to be activated successively for each T_{d} for a period substantially equal to 2^{c+d}*T.

8. The method as claimed in claim 7, the control signals being such that:
$${SC}_{l , j , i} = ( {\sum }_{d = {a}_{j}}^{{b}_{l}} PW ( d - {a}_{l} ) * {W}_{j , i} [ d ] ) ( {\sum }_{c = 0}^{{n}_{X} - 2} PX ( c ) * {X}_{j} [ c ] ) , l ∈ \{ 0 , … , k - 1 \} .$$

9. The method as claimed in claim 1, the voltage V_{O}_{ᵢ} across the terminals of the accumulation line (AL) for a multiplication and accumulation operation being equal to:
$${V}_{{O}_{i}} = \frac{I * T * {O}_{i}}{C}$$
C being the value of the capacitance of the accumulation line and I being the intensity of the current of the least significant current source (i.e. for aₗ=0).

10. A circuit for performing in-memory multiplication and accumulation (MAC) operations for a neural network, configured to determine the result of the matrix product O of a vector X=[X₁ X₂ . . . , Xₘ] including m elements, each represented on (n_{X}−1) bits, and a matrix
$$W = [ \begin{matrix}{W}_{1 , 1} & ⋯ & {W}_{n , 1} \\ ⋮ & ⋱ & ⋮ \\ {W}_{m , 1} & ⋯ & {W}_{m , n}\end{matrix} ]$$
including a×n elements, each represented on (n_{W}−1) bits:
$$O = [ \begin{matrix}{X}_{1} & {X}_{2} & … & {X}_{m}\end{matrix} ] \times [ \begin{matrix}{W}_{1 , 1} & ⋯ & {W}_{n , 1} \\ ⋮ & ⋱ & ⋮ \\ {W}_{m , 1} & ⋯ & {W}_{m , n}\end{matrix} ] = [ \begin{matrix}{O}_{1} & {O}_{2} & … & {O}_{n}\end{matrix} ]$$
each element of the matrix product O being the sum of scalar products
$${O}_{i} = {\sum }_{j = 1}^{m} {R}_{j , i} with {R}_{j , i} = ( {\sum }_{c = 0}^{{n}_{X} - 2} {2}^{c} {X}_{j} [ c ] ) ( {\sum }_{d = 0}^{{n}_{W} - 2} {2}^{d} {W}_{j , i} [ d ] ) , i ∈ \{ 1 , … , n \} , j ∈ \{ 1 , … , m \} ,$$
with the bit vector Xⱼ=[Xⱼ[0], . . . , Xⱼ[n_{X}−2]] and the weight bit vector W_{j,i}=[W_{j,i}[0], . . . , W_{j,i}[n_{W}−2]], the circuit comprising:
a logic unit comprising logic gates to which the values of the vectors Xⱼ and W_{j,i} and those of associated time masks are applied, the time masks PX=[PX(0), . . . , PX(n_{X}−2)] being associated with the bits of the elements of the vector Xⱼ and the time masks PW=[PW(0), . . . , PW(n_{W}−2)] being associated with the bits of the elements of the vector W_{j,i}, the logic unit being configured to generate, at its output, at least one control signal SC for activating at least one current source; and
said at least one current source configured to be activated by the control signal SC so as to accumulate capacitive charges in an accumulation line.

11. (canceled)

12. (canceled)

13. The circuit as claimed in claim 10, wherein the logic unit comprising NAND and/or NOR logic gates, and
the logic unit comprising a first logic subunit for time masking the bits Xⱼ and a second logic subunit for time masking the weight bits W_{j,i}, these two subunits being cascaded so that the outputs of the first subunit are at the input of the second subunit.

14. The circuit as claimed in claim 13, the first subunit receiving, at its input, the time masks PX and PW and also the bits Xⱼ[0: n_{X}−2], and comprising two logic gate stages:
a first stage comprising multiple logic gate levels, the levels being connected in cascade so that the signal or signals at the output of one level are the signal or signals at the input of the next level until a single signal is eventually obtained at the output, said first stage being one in which each bit Xⱼ[0: n_{X}−2] and the associated time mask PX are at the input of a first-level logic gate, in particular a NAND or NOR gate; and
a second stage comprising at least one logic gate level, in which the signal at the output of the first stage and each time mask PW are at the input of a logic gate of said level, in particular a NAND or NOR gate.

15. The circuit as claimed in claim 14, the second subunit receiving, at its input, the signals at the output of the first subunit and the weight bits W_{j,i}[0: n_{W}−2] and comprising multiple logic gate levels, the levels being connected in cascade so that the signal or signals at the output of one level are the signal or signals at the input of the next level until a single signal corresponding to the control signal is eventually obtained at the output, each first-level logic gate receiving, at its input, a signal at the output of the first subunit and the corresponding weight bit W_{j,i}[0: n_{W}−2].

16. The circuit as claimed in claim 15, wherein at least one of the two vectors being signed, Xⱼ[sign] being the sign bit of the vector Xⱼ and/or W_{j,i}[sign] being the sign bit of the weight bit vector W_{j,i}, said accumulation line (AL) being configured to be charged or discharged according to a polarity signal SP=Xⱼ[sign]×W_{j,i}[sign], this signal SP being obtained in particular at the output of an XOR or XNOR logic gate receiving, at its input, the sign bit Xⱼ[sign] and the sign bit W_{j,i}[sign], and
further comprising an XOR or XNOR gate receiving, at its input, the sign bit Xⱼ[sign] of the bit vector Xⱼ and the sign bit W_{j,i}[sign] of the bit vector W_{j,i}.

17. The circuit as claimed in claim 10, said at least one current source being created by current mirrors using CMOS transistors.

18. The circuit as claimed in claim 17, the current mirrors comprising PMOS transistors for charging the accumulation line and NMOS transistors for discharging said line.

19. (canceled)

20. The circuit as claimed in claim 10, comprising at least one electronic switch, which is in particular a pass gate, controlled by the control signal to activate said at least one current source.

21. The circuit as claimed in claim 10, comprising at least one capacitor at the output of said at least one electronic switch to increase the capacitance of the accumulation line.

22. (canceled)

23. (canceled)

24. The circuit as claimed in claim 10, further comprising a secondary accumulation line connected to the accumulation line by way of a follower amplifier; and
an analog-to-digital converter connected either directly to the accumulation line in the absence of a secondary accumulation line or to the secondary accumulation line, in particular by means of a follower amplifier.

25. (canceled)

26. (canceled)

27. (canceled)

28. (canceled)

29. (canceled)

30. (canceled)

31. (canceled)

32. The circuit as claimed in claim 24, the analog-to-digital converter comprising:
two analog comparators, each configured to compare the voltage of the accumulation line to which the analog-to-digital converter is connected with a predefined threshold: a first comparator that compares said voltage with a high voltage threshold V_{H}, in particular +LSB, and is configured to be activated when the voltage of the accumulation line is greater than V_{H}, and a second comparator that compares the voltage of the accumulation line with a low voltage threshold V_{L}, in particular with −LSB, and is configured to be activated when the voltage of the accumulation line is less than V_{L};
a digital unit configured to convert the results of the comparisons into two separate output signals: a first signal indicating activation of one of the two comparators and a second signal specifying which of the two comparators has been activated;
a counter configured to be incremented or decremented according to the signals at the output of the digital unit, and the output of which is that of the converter;
a charge injector unit connected to the outputs of the digital unit and configured to return the charge of the accumulation line connected to the converter to its initial value if the digital unit indicates that this line has been discharged; and
a discharger unit connected to the outputs of the digital unit and configured to discharge the accumulation line connected to the converter and return it to its initial value if the digital unit indicates that this line has been charged.

33. (canceled)

34. (canceled)

35. (canceled)

36. (canceled)
